(19) United States
(12) Patent Application Publication
(10) Pub. No.: US 2022/0397756 A1
(43) Pub. Date: Dec. 15, 2022

(54) OPTICAL SCANNING DEVICE

(71) Applicant: Coretronic Corporation, Hsin-Chu (TW)

(72) Inventors: Kang-Hsi Li, Hsin-Chu (TW); Kuan-Wei Pan, Hsin-Chu (TW)

(73) Assignee: Coretronic Corporation, Hsin-Chu (TW)

(21) Appl. No.: 17/824,919

(22) Filed: May 26, 2022

(30) Foreign Application Priority Data
Jun. 9, 2021 (CN) 202110640425.9

(51) Int. Cl. G02B 26/08; G02B 26/10; G02B 7/182

(52) U.S. Cl. CPC G02B 26/0833; G02B 26/10; G02B 7/1821; G02B 27/30

(57) ABSTRACT

An optical scanning device includes a substrate, a frame, a plurality of light source modules, and a scanning mirror assembly. The frame is disposed on the substrate to form an accommodating space, and includes a side wall and a reflective portion located on a top end of the side wall and having a light exit. The light source modules are disposed in the accommodating space, surround the scanning mirror assembly, and are configured to provide a plurality of light beams to the reflective portion. The scanning mirror assembly is disposed in the accommodating space and located on a transmission path of the light beams reflected by the reflective portion. The scanning mirror assembly includes a scanning element oscillating along at least one rotation axis and being configured to reflect the light beams to form a scanning light beam transmitted through the light exit out of the optical scanning device.

### CROSS-REFERENCE TO RELATED APPLICATION

This application claims the priority benefit of Chinese application no. 202110640425.9, filed on Jun. 9, 2021. The entirety of the above-mentioned patent application is hereby incorporated by reference herein and made a part of this specification.

### BACKGROUND

### Technical Field

The disclosure relates to an optical device, and particularly, to an optical scanning device.

### Description of Related Art

An optical radar, or referred to as LiDAR (light detection and ranging), is an optical remote sensing technology, which measures parameters of, such as a distance from, a target by irradiating a light beam, usually a pulsed laser, to the target. A laser radar has applications in geomatics, archaeology, geography, geomorphology, seismology, forestry, remote sensing, and atmospheric physics, among other fields. In addition, this technology is also used in specific applications such as airborne laser mapping, laser altimetry, and laser radar contour line illustration.

The existing optical radar technology mainly include two major categories, i.e., the scanning mode and non-scanning mode. Among them, the scanning optical radar commonly used in a vehicle-mounted device is more of a current research and development hotspot. The scanning optical radar generally includes the mechanical scanning technology and microelectromechanical systems (MEMS) scanning technology. In a mechanical optical radar, a whole optical engine is taken as a moving part, and is driven by a driving element to rotate the optical engine in order to achieve scanning. In the meanwhile, in the microelectromechanical systems scanning technology, an oscillating mirror of microelectromechanical systems is swung back and forth, so that a light beam incident on the mirror at different deflection angles is emitted at different angle in order to achieve scanning.

Currently, relevant manufacturers are mostly focusing on developing the microelectromechanical systems scanning optical radar, since it is smaller in size and achieves higher-frequency scanning through the mirror. However, since the light source requires collimation, it is required to address the space for additionally disposing optical components, and has the problem related to the incident angle of the light source, the reflection angle of the mirror, and the emitting angle of the scanning light. As such, in the existing design, the light source needs to be spaced apart from the mirror by a certain distance, and it is thus difficult to further reduce the volume of the optical engine.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides an optical scanning device, in which the size of an optical radar can be greatly reduced, and a good optical effect is provided.

Other objectives and advantages of the disclosure may be further understood from the technical features disclosed in the disclosure.

In order to achieve one, some, or all of the above objectives or other objectives, an embodiment of the disclosure provides an optical scanning device, which includes a substrate, a frame, a plurality of light source modules, and a scanning mirror assembly. The frame is disposed on the substrate to form an accommodating space. The frame includes a side wall and a reflective portion. The reflective portion is located on a top end of the side wall, and the reflective portion has a light exit. The light source modules are disposed in the accommodating space and surround the scanning mirror assembly. The light source modules are configured to provide a plurality of light beams to the reflective portion. The scanning mirror assembly is disposed in the accommodating space and located on a transmission path of the light beams reflected by the reflective portion. The scanning mirror assembly includes a scanning element oscillating along at least one rotation axis and being configured to reflect the light beams to form a scanning light beam. The scanning light beam is transmitted through the light exit out of the optical scanning device.

Based on the foregoing, the embodiments of the disclosure have at least one of the following advantages or effects. In the optical scanning device of the disclosure, by disposing the light source modules on the periphery of the scanning mirror assembly, and configuring the emitting direction of the light beam from the light source modules to be substantially the same as the direction which the scanning mirror assembly faces, an optical scanning device with a compact arrangement and small volume is formed. The frame having the reflective surface and the light exit is utilized to surround the light source modules and the scanning mirror assembly. The light beams emitted from the light source modules are reflected by the reflective surface to be obliquely incident on the scanning mirror assembly, and then are reflected by the scanning mirror assembly to form the scanning light beam to be emitted from the light exit of the frame. In this way, the reflective surface does not block the light path of the scanning light beam, and the conventional reflective mirror is combined with the frame. Compared with the existing products, the volume is further reduced and the reliability is improved.

Other objectives, features and advantages of the invention will be further understood from the further technological features disclosed by the embodiments of the invention wherein there are shown and described preferred embodiments of this invention, simply by way of illustration of modes best suited to carry out the invention.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic perspective view of an optical scanning device according to an embodiment of the disclosure.

FIG. 2 is a schematic perspective exploded view of the optical scanning device of FIG. 1.

FIG. 3 is a schematic cross-sectional view of the optical scanning device of FIG. 1.

FIG. 4 is another schematic cross-sectional view of the optical scanning device of FIG. 1.

FIG. 5A and FIG. 5B are respectively schematic cross-sectional views of the optical scanning device of FIG. 1 operating at different timings.

FIG. 6 is a schematic diagram illustrating timings during operation of the optical scanning device of FIG. 5A and FIG. 5B.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

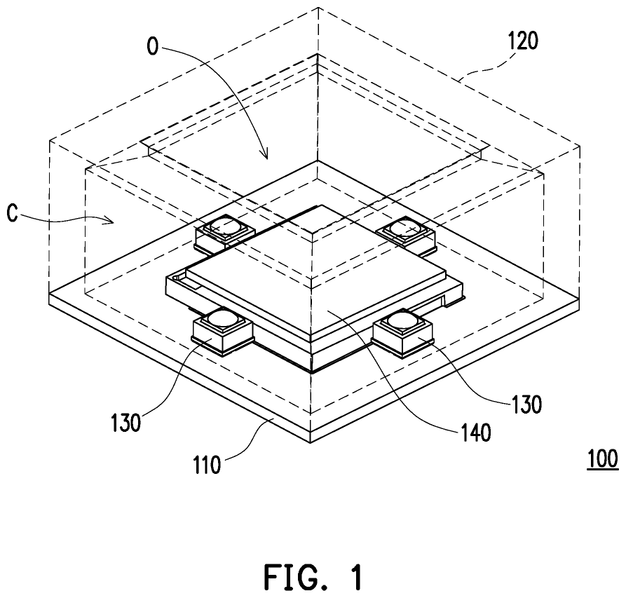

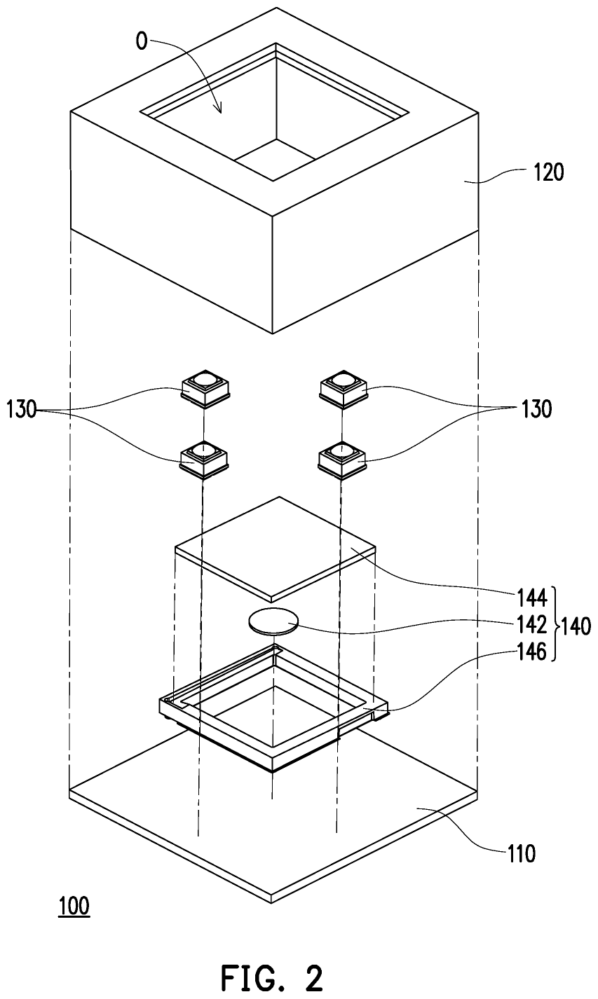

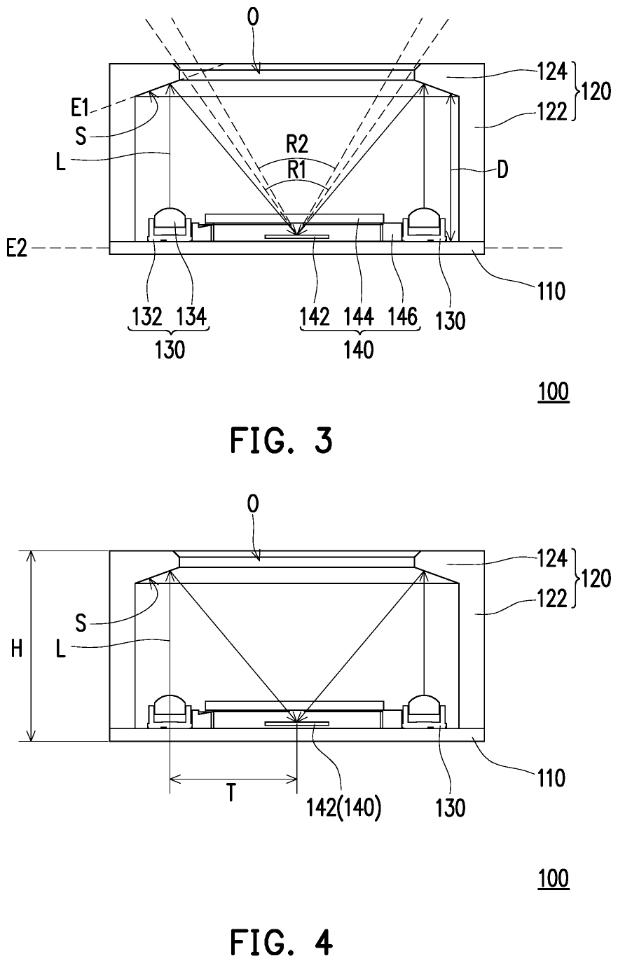

FIG. 1 is a schematic perspective view of an optical scanning device according to an embodiment of the disclosure. FIG. 2 is a schematic perspective exploded view of the optical scanning device of FIG. 1. FIG. 3 is a schematic cross-sectional view of the optical scanning device of FIG. 1. With reference to FIG. 1 to FIG. 3 together, this embodiment provides an optical scanning device 100, which includes a substrate 110, a frame 120, a plurality of light source modules 130, and a scanning mirror assembly 140. The optical scanning device 100 is, for example, a light-emitting end device of an optical radar, and is configured to provide a light beam L to a target (not shown), such that a receiving end device of the optical radar obtains relevant information (e.g., position and area) of the target through a scanning light beam reflected by the target. The light-emitting end device may be disposed on the periphery of the receiving end device, such that emitting direction of the scanning light beam is substantially the same as the receiving direction of the scanning light beam of the receiving end device. Accordingly, the size of the optical radar can be reduced.

The substrate 110 is, for example, at least one circuit board, where the light source modules 130, the scanning mirror assembly 140, and other electronic components may be disposed. In this embodiment, the light source modules 130 and the scanning mirror assembly 140 are disposed on the same plane of the substrate 110. However, in some embodiments, the light source modules 130 and the scanning mirror assembly 140 may also be disposed on different planes, and the disclosure is not limited thereto.

The light source modules 130 are disposed on the substrate 110 and surround the scanning mirror assembly 140. In this embodiment, each light source module 130 includes a light-emitting element 132 and a collimator 134. Taking one light-emitting element 132 and one collimator 134 as an example, the light-emitting element 132 is configured to provide the light beam L, while the collimator 134 is disposed on a transmission path of the light beam L, and is configured to collimate the light beam L. For example, in this embodiment, the light-emitting elements 132 take, for example, a vertical-cavity surface-emitting laser (VCSEL) as a light source, but the disclosure is not limited thereto. In this embodiment, a wavelength of the light beam L is, for example, 850 nanometers, 905 nanometers, 940 nanometers, 1550 nanometers, or other wavelengths of infrared.

The scanning mirror assembly 140 is disposed on the substrate 110. The scanning mirror assembly 140 includes a scanning element 142 oscillating along at least one rotation axis. The at least one rotation axis is parallel to the substrate 110, for example. The scanning element 142 is, for example, a scanning mirror of microelectromechanical systems, and is configured to reflect and transmit the light beam L out of the optical scanning device 100.

In this embodiment, the scanning mirror assembly 140 further includes an optical member 144. The optical member 144 is disposed on the transmission path of the light beam L and covers the scanning element 142. Specifically, the scanning mirror assembly 140 further includes a frame-shaped support member 146 disposed on the substrate 110 to surround the scanning element 142. The optical member 144 is disposed on the support member 146 to cover the scanning element 142. For example, the optical member 144 may be a plastic cover plate, a glass cover plate, or a light-transmitting member having a coating, and is configured to serve the dust-proof, anti-fouling, anti-reflection and/or filtering (e.g., filtering out visible light) functions.

The frame 120 is disposed on the periphery of the substrate 110 and forms an accommodating space C together with the substrate 110. The accommodating space C is configured to accommodate the light source modules 130, the scanning mirror assembly 140, and other electronic components. The frame 120 includes a side wall 122 and a reflective portion 124. The reflective portion 124 is located on a top end of the side wall 122, as shown in FIG. 3. The reflective portion 124 has a light exit O, and the light exit O is located in a top region of the frame 120. As such, the reflective portion 124 surrounds the light exit O. In this embodiment, the reflective portion 124 includes a reflective surface S, which is located on one side of the reflective portion 124 facing the scanning mirror assembly 140. The reflective surface S has a coating with, for example, a metal or a dielectric material to form a reflective surface. In addition, in this embodiment, each of inner surfaces except the reflective surface S of the frame 120 is a black surface to prevent that a scanning light beam X that is not smoothly emitted is reflected multiple times in the accommodating space C and is emitted from the light exit O at other angles or is directly emitted from the frame 120, causing the optical radar to receive signal noise.

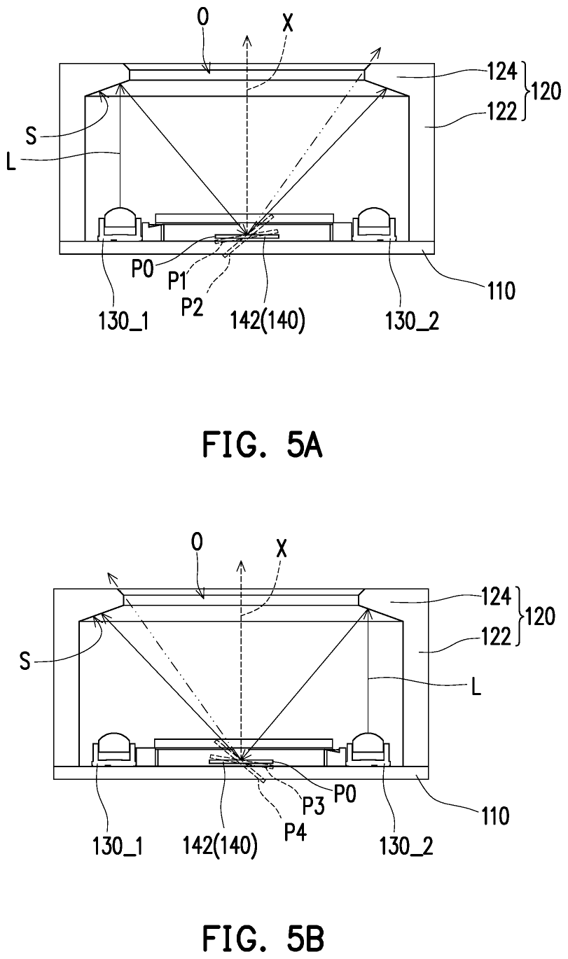

During scanning, the light source modules 130 transmit the light beams L to the reflective portion 124 of the frame 120. The reflective portion 124 of the frame 120 reflects the light beams L to the scanning element 142 of the scanning mirror assembly 140. To be specific, the light beams L are reflected by the reflective surface S of the reflective portion 124. A reference plane E1 of the reflective surface S is inclined to a reference plane E2 of the substrate 110, as shown in FIG. 3. In this embodiment, a distance D from the reflective surface S to the substrate 110 is gradually reduced from a side end of the light exit O to a side end of the side wall 122. The scanning element 142 reflects the light beams L to form the scanning light beam X (as shown in FIG. 5A) by the oscillation of the microelectromechanical systems. The scanning light beam X is emitted from the light exit O of the frame 120 to depart from the optical scanning device 100. Accordingly, the volume of the optical radar can be greatly reduced, and a good optical effect is provided.

Taking one-dimensional scanning as an example, at least one light source module 130 is disposed on each of two opposite sides of the scanning mirror assembly 140, and the light source module 130 provides the light beam L along a direction perpendicular to the substrate 110. The light beam L is transmitted to the reflective surface S of the top portion of the frame 120. After the light beam L is transmitted by the reflective surface S at a predetermined angle to the scanning mirror assembly 140, the light beam L is reflected by the scanning element 142 oscillating back and forth to form the scanning light beam X, such that the scanning light beam X is emitted through the light exit O, forming a scanning angle R2 (i.e., the region where the scanning light beam X passes through the light exit O) as shown in FIG. 3. An opening angle R1 of the light exit O (representing the maximum angle at which the scanning light beam X irradiates the edge of the light exit O) is greater than the scanning angle R2. By controlling the reflection angle of the scanning mirror assembly 140, the scanning angle R2 at which the scanning light beam X is emitted is set to be smaller than the opening angle R1, such that the scanning mirror assembly 140 causes the scanning light beam X to be completely emitted through the light exit O without being blocked by the frame 120.

FIG. 4 is another schematic cross-sectional view of the optical scanning device of FIG. 1. With reference to FIG. 3 and FIG. 4, it is worth noting that the opening angle of the frame 120 may be affected by the overall aspect ratio. A height H is a distance from the substrate 110 to the top surface of the frame 120, and a width T is a distance from the geometric center of the light source module 130 to the geometric center of the light exit O. Therefore, different scanning angles may be provided by different aspect ratios. For example, when the aspect ratio is 2:3, the inclination angle between the reflective surface S and the horizontal plane (e.g., the reference plane E2 of the substrate) is 20 degrees, and the oscillation angle of the scanning element 142 is about plus or minus 20 degrees, such that the scanning angle R2 reaches 70 degrees in scanning. When the aspect ratio is 1:1, the inclination angle between the reflective surface S and the horizontal plane is 27.7 degrees, and the oscillation angle of the scanning element 142 is about plus or minus 27.7 degrees, such that the scanning angle R2 reaches 90 degrees in scanning. In other words, the user may select the frame 120 with different aspect ratios according to the required scanning angles. In a preferred embodiment, the incident angle of the reflective surface S of the frame 120 is designed to be the same as the oscillation angle of the scanning element 142, to prevent that the scanning light beam X cannot smoothly pass through the light exit O at a large oscillation angle, and is again incident on the reflective surface S or other parts of the frame 120, resulting in noise.

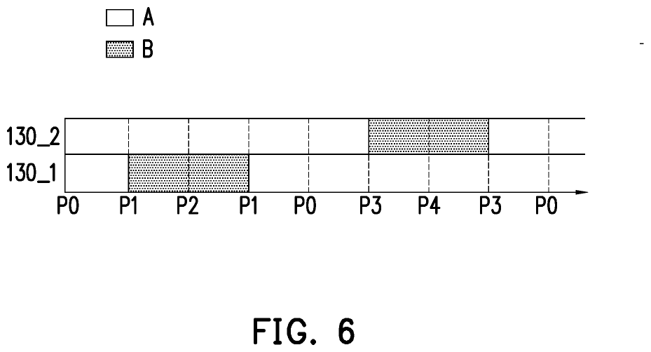

FIG. 5A and FIG. 5B are respectively schematic cross-sectional views of the optical scanning device of FIG. 1 operating at different timings. FIG. 6 is a schematic diagram illustrating timings during operation of the optical scanning device of FIG. 5A and FIG. 5B. With reference to FIG. 5A to FIG. 6, during actual operation in this embodiment, in order to match the inclination angle of the reflective surface S, the light source module 130 disposed on the periphery of the scanning mirror assembly 140 is configured with different turn-on/off timings corresponding to the current deflection angle of the scanning element 142. When the light beam L is emitted by the light source module 130 and is reflected by the reflective surface S to the scanning element 142, the scanning light beam X generated by the scanning element 142 is transmitted in different directions according to the current different deflection angles of the scanning element 142. In most cases of operation, the scanning element 142 may sequentially oscillate back and forth between two fixed deflection angles. Under special requirements, the scanning element 142 may also be further adjusted to oscillate only at a small angle within the range of the deflection angle, or oscillate according to other customized sequences. Since it is possible that the scanning element 142 reflects the scanning light beam X to the opposite reflective surface S, in order to prevent noise caused by multiple times of reflection of the scanning light beam X that cannot be emitted from the light exit O in the frame 120, one and the other of two opposite light source modules 130 (hereinafter referred to as a first light source module 130_1 and a second light source module 130_2) may be configured with different turn-on timings.

For example, as shown in FIG. 5A, during a period when the scanning element 142 rotates from a position P0 to a position P1, the light source module 130_1 is not activated, as shown by a region A in FIG. 6. During a period when the scanning element 142 rotates from the position P1 to a position P2 and during a period when the scanning element 142 rotates from the position P2 to the position P1, the light source module 130_1 is activated, as shown by a region B in FIG. 6. During a period when the scanning element 142 rotates from the position P0 to a position P3, the light source module 130_1 and the light source module 130_2 are turned off. Next, as shown in FIG. 5B, during a period when the scanning element 142 rotates from the position P3 to a position P4 and during a period when the scanning element 142 rotates from the position P4 to the position P3, the light source module 130_2 is activated. During a period when the scanning element 142 rotates from the position P3 to the position P0, the light source module 130_2 is turned off. In this way, it can be ensured that the scanning light beam X is smoothly transmitted from the light exit O out of the optical scanning device 100, without being transmitted to the opposite reflective surface S, which can further improve the light use efficiency and prevent noise.

The optical scanning device 100 of this embodiment may also be applied to a two-dimensional or multi-dimensional continuously scanning system, in which the configuration and turn-on/off sequence of the light source modules 130 and the deflection manner of the scanning element 142 may be sufficiently taught, suggested, and described for implementation from common general knowledge in the related field, and therefore will not be repeatedly described.

In summary of the foregoing, in the optical scanning device of the disclosure, by disposing the light source modules on the periphery of the scanning mirror assembly, and configuring the emitting direction of the light source modules to be substantially the same as the direction which the scanning mirror assembly faces, an optical scanning device with a compact arrangement and small volume is formed. The frame having the reflective surface and the light exit is utilized to surround the light source modules and the scanning mirror assembly. The light beams emitted from the light source modules are reflected by the reflective surface to be obliquely incident on the scanning mirror assembly, and then are reflected by the scanning mirror assembly to form the scanning light beam to be emitted from the light exit of the frame. In this way, the reflective surface does not block the path of the scanning light beam, and the conventional reflective mirror is combined with the frame. Compared with the existing products, the volume is further reduced and the reliability is improved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. An optical scanning device, comprising a substrate, a frame, a plurality of light source modules, and a scanning mirror assembly, wherein
the frame is disposed on the substrate to form an accommodating space, and comprises a side wall and a reflective portion, wherein
the reflective portion is located on a top end of the side wall, and the reflective portion has a light exit;
the light source modules are disposed in the accommodating space and surround the scanning mirror assembly, and are configured to provide a plurality of light beams to the reflective portion; and
the scanning mirror assembly is disposed in the accommodating space and located on a transmission path of the light beams reflected by the reflective portion, wherein the scanning mirror assembly comprises a scanning element oscillating along at least one rotation axis and being configured to reflect the light beams to form a scanning light beam, and the scanning light beam is transmitted through the light exit out of the optical scanning device.

2. The optical scanning device according to claim 1, wherein the reflective portion comprises a reflective surface located on one side of the reflective portion facing the scanning mirror assembly.

3. The optical scanning device according to claim 2, wherein a reference plane of the reflective surface is inclined to a reference plane of the substrate.

4. The optical scanning device according to claim 2, wherein a distance from the reflective surface to the substrate is gradually reduced from a side of the light exit to a side of the side wall.

5. The optical scanning device according to claim 2, wherein each of inner surfaces except the reflective surface of the frame is a black surface.

6. The optical scanning device according to claim 1, wherein the light exit has an opening angle, and the opening angle is greater than a scanning angle of the scanning light beam.

7. The optical scanning device according to claim 1, wherein a wavelength of the light beams is 850 nanometers, 905 nanometers, 940 nanometers, or 1550 nanometers.

8. The optical scanning device according to claim 1, wherein the light source modules comprise a plurality of light-emitting elements and a plurality of collimators, the light-emitting elements are respectively configured to provide the light beams, and the collimators are respectively disposed on the transmission path of the light beams.

9. The optical scanning device according to claim 8, wherein the light-emitting elements comprise a vertical-cavity surface-emitting laser.

10. The optical scanning device according to claim 1, wherein the light source modules and the scanning mirror assembly are located on a same plane.

11. The optical scanning device according to claim 1, wherein the scanning mirror assembly further comprises an optical member disposed on the transmission path of the light beams to cover the scanning element, and the optical member comprises a light-transmitting protective cover, a filter, or an optical lens.
